(19) United States
(12) Patent Application Publication
(10) Pub. No.: US 2010/0260330 A1
(43) Pub. Date: Oct. 14, 2010

(54) SENDING OF CONNECTED LINE INFORMATION FOR A FOLLOW-ON CALL IN AN INTELLIGENT NETWORK

(76) Inventors: Rogier August Caspar Joseph Noldus, Goirle (NL); Alfonso Pisani, Scafati (IT); Biagio Maione, Napoli (IT)

Correspondence Address: ERICSSON INC., 6300 LEGACY DRIVE, M/S EVR 1-C-11, PLANO, TX, 75024, US

(21) Appl. No.: 12/747,829

(22) PCT Filed: Dec. 13, 2007
(86) PCT No.: PCT/NL07/50646

§ 371 Date: Jun. 11, 2010

(51) Int. Cl. H04M 7/00

(52) U.S. Cl. 379/221.04

(57) ABSTRACT

The invention relates to a method for transmitting connected line information to a calling entity in a telecommunications network. A first connection between a calling entity and a first remote entity has been disconnected. The telecommunications network comprises a service control entity and a service switching entity. The service switching entity performs:—receiving a first instruction from the service control entity to establish a second connection between the calling entity and a second remote entity,—receiving a second instruction from the service control entity comprising a connected line notification indicator, receiving an indication that the second connection between the calling entity and the second remote entity has been established comprising connected line information of the second remote entity. The method further comprises—based on the connected line notification indicator sending towards the calling entity a message comprising the connected line information of the second remote entity.

### TECHNICAL FIELD

The invention relates to a method for transmitting connected line information to a calling entity in a telecommunications network, a service switching entity adapted to perform the method, a service control entity adapted to perform the method, a computer program loadable into a processing unit of a service control entity or a service switching entity, the computer program comprising portions of software code adapted to perform the method, and a computer-readable medium product comprising such a computer program.

### BACKGROUND

A network may be provided enabling communication entities to communicate with each other. The communication entities may be wireline telephones, mobile telephones or any other suitable device. The communication entities that initiate communication may be referred to as calling entities and the communication entities with which the calling parties initiate communication are referred to as remote entities or called entities. Once a connection is established with a remote entity, this remote entity may be referred to as a connected entity.

In the telecommunications network a call initiated by a calling entity and destined for a remote entity is routed through a number of switching nodes before this call reaches its destination. An example of how a call may be routed from a calling entity to a remote entity in a telecommunications network is given with reference to FIG. 1. A calling entity CE-A sets up a call to a remote entity RE-B by sending a call set up request message to a switching node 101. The switching node 101 receives the call set up request message and analyses the destination number comprised therein, i.e. typically a number associated to remote entity RE-B. Depending on the outcome of the analysis the switching node 101 will select the most appropriate next switching node for routing the call further in the most efficient way. In this example the switching node 101 selects a switching node 102. Switching nodes 102 and 103 behave in a similar way and route the call further towards switching node 104, which is closest to the remote entity RE-B. Switching nodes 102 and 103 are sometimes also referred to as transit switching nodes, because they function as transits between switching nodes 101 and 104. The switching node 104 then connects the incoming call to remote entity RE-B and a speech connection may be opened between calling entity CE-A and remote entity RE-B.

Connected Line Identification Presentation (COLP)

Connected Line Identification Presentation (COLP) is a Supplementary Service providing a calling entity CE-A with the possibility to receive the line identity of the remote entity RE-B. The COLP service is specified for example in 3^{rd} Generation Partnership Project (3GPP) Technical Specification (TS) 23.081.

This service is not intended to allow the calling entity CE-A to check if the dialled number is correct, but is an indication for the calling entity CE-A of the identity of the remote entity RE-B. The identity of the connected entity constitutes information facilitating the calling entity CE-A to unambiguously identify the connected entity; this connected line identity is not always similar to the dialled number associated to remote entity RE-B, for instance in case of call forwarding.

Associated with the COLP Supplementary Service is the Connected Line Identification Restriction (COLR) Supplementary Service. The COLR Supplementary Service enables the connected entity to prevent presentation of its line identity to the calling entity CE-A. If the COLR Supplementary Service is applicable to the call, the calling entity CE-A, which had requested to receive the connected line information (COL information) for this call, will receive instead an indication that the connected line information COL is not available for presentation due to restriction.

Depending on national regulations, some networks may define categories of subscribers, for instance the police force, that have the ability to override the presentation restriction due to COLR and have the connected line information, if available, presented in all cases.

In addition to supplementary services as COLP, i.e. services executed by and under the control of switching nodes, also services may be provided that are executed and controlled by Intelligent Networks. According to the Intelligent Network (IN) concept, service intelligence or service logic is separated from switching functions. This separation enables network operators to develop and deploy services and features independently of network vendors, allowing more flexibility in service development, simplified rollout, reduced cost and greater autonomy. Examples of IN protocols are the Intelligent Network Application Protocol (INAP), the Advanced IN (AIN), and the Customized Applications for Mobile network Enhanced Logic (CAMEL). INAP was developed for fixed line networks and is the primary protocol used for fixed line IN outside of North America. AIN is a variant developed for North America.

CAMEL

CAMEL is a Global System for Mobile communications (GSM) Phase 2+ and Universal Mobile Telecommunication System (UMTS) network feature. CAMEL is based on core INAP with modifications to take into account, amongst others, subscriber mobility. In particular, CAMEL enables the use of operator-specific services by a subscriber even when roaming outside the subscriber's Home Public Land Mobile Network (Home PLMN, HPLMN). A CAMEL based Intelligent Network comprises as main entities a service switching entity for switching tasks, also referred to as SSF (Service Switching Function) or gsmSSF (GSM Service Switching Function) and a service control entity comprising the service intelligence or logic also referred to as SCF (Service Control Function) or gsmSCF (GSM Service Control Function).

CAMEL is specified in the following 3GPP Technical Specifications (TS): 22.078, 23.078 and 29.078.

Before CAMEL, IN services were mainly implemented by using INAP CS1 (standard) and CS1+ (Ericsson proprietary) protocols. The problem was that these protocols were developed for fixed line applications and so could not completely fit for mobile applications.

CAMEL phase 4 is the final phase of 3GPP CAMEL standard and will constitute the maximum set of service capabilities that CAMEL has to offer. With CAMEL phase 4, it will be possible to realize any service application that so far could only be offered through proprietary IN protocols, such as Ericsson INAP CS1+.

Such applications can now be replaced with a CAMEL compliant implementation which will make them suitable for multi-vendor interoperability as well as inter-network roaming.

FIG. 2 depicts a schematic overview of a telecommunications network comprising an intelligent network.

The intelligent network comprises a service control entity SCE and a service switching entity SSE, which will both be explained in more detail below. Furthermore, switching nodes 203, 204 and 205 are depicted, each of which may be a Mobile Services Switching Centre (MSC). The switching node 203 may function as an originating node; the switching node 204 may be a transit switching node and the switching node 205 may be a terminating node. In the case that the calling entity CE-A is a mobile entity, originating node 203 may typically be a Serving MSC for the calling entity CE-A. In the case that the remote entity RE-B is a mobile subscriber, transit switching node 204 may typically be a Serving GMSC for the remote entity RE-B and terminating node 205 may typically be a Serving MSC for the remote entity RE-B.

Intelligent networks services are executed at the service control entity SCE. The service control entity SCE is able to communicate with the service switching entity SSE using an intelligent network protocol such as CAMEL or INAP. The service switching entity SSE is preferably co-located at a transit switching node 204, but may also be co-located at any of the other types of switching nodes 204, 205.

The service control entity SCE has a leading role in the intelligent network and decides about which services are admitted or refused. It sends instructions to the service switching entity SSE to be carried out by the service switching entity SSE.

It will be understood that a call establishment procedure to set up a connection within a network comprises a plurality of call establishment messages being exchanged in the network.

According to an example, the connected line information (COL information) may be conveyed by the network in the connected number parameter of the ISUP Answer Message (ANM) or ISUP Connect (CON) message. The ISUP Answer (ANM) and the ISUP Connect (CON) are both examples of call establishment messages that may be part of the call establishment procedure. ISUP ANM and ISUP CON indicate that a call connection has been established between the calling entity CE-A and the connected entity RE-B and that media (e.g. speech) may now be exchanged between the calling entity CE-A and the connected entity RE-B.

It will be understood by the person skilled in the art that when signalling takes place within a switching node such as a mobile services switching centre MSC, or between a mobile services switching centre MSC and an associated service switching entity SSE, the signalling may be a node-internal version of ISUP. It is further understood that signalling external to switching nodes may be ISUP or other protocols such as Bearer independent call control (BICC) or the Session initiation protocol (SIP). It is further assumed to be understood that the signalling protocol between a GSM mobile station and the mobile services switching centre MSC is Direct transfer application part (DTAP).

When a call is subjected to the control of a service control entity SCE using, for instance, the CAMEL call control protocol, the service control entity SCE is linked in the traffic chain for controlling the call and/or to be notified of events happening during the call establishment procedure or during the active phase of the call. The service control entity SCE may send a message to the service switching entity SSE indicating whether or not COLP may be applied for the calling entity CE-A for this call, i.e. whether connected line information COL, if received in ISUP ANM or ISUP CON, may be provided to the calling entity CE-A. The result of the above-mentioned message, sent from the service control entity SCE to the service switching SSE, is that a connected line information flag will be set in the service switching entity SSE, indicating whether or not connected line information COL may be forwarded to the calling entity CE-A.

The CAMEL service, residing in the service control entity SCE, may be invoked due to a CAMEL subscription (CSI) information element like the Originating call CSI (O-CSI), the Dialed service CSI (D-CSI), Network based service CSI (N-CSI) or due to a Trunk originated service triggering CSI (TO-CSI). When CAP v3 or CAP v4 is used for the CAMEL service invocation, the CAMEL service may send the ‘Service interaction indicators two’ (SII2) parameter to the service switching entity SSE. The SII2 would be conveyed in a Connect (CON) operation or in a Continue with argument (CWA) operation. The SII2 parameter may, in turn, include the ‘Connected number treatment indicator’ (CNTI) parameter. The CNTI indicates, for the call, to the service switching entity SSE whether the connected line information COL, when received in ISUP ANM or in ISUP CON, may be provided to the calling entity CE-A.

A problem may occur when the service control entity SCE instructs the service switching entity SSE to establish a call and allows connected line information COL for this call to be provided to the calling entity CE-A, but connected line information COL had potentially already been sent towards the calling entity CE-A for this call. This may for example occur when the control entity SCE instructs the establishment of a second connection for the calling entity CE-A within a call, and the connected line information COL has been sent towards the calling entity CE-A with respect to a first connection within the same call. When the service switching entity SSE receives ISUP ANM or ISUP CON for this second connection, including connected line information COL, then the service switching entity SSE, in cooperation with the mobile services switching centre MSC, will not be able to provide the connected line information COL to the calling entity CE-A, since the calling entity CE-A had received connected line information COL already during this call.

This situation may for instance occur for a follow-on call or when user interaction with the calling entity CE-A occurs before the call establishment procedure is completed, for instance before the call is routed towards the requested destination. In both situations a call answer message is sent towards the calling entity CE-A with respect to the first connection before the second connection with the final connected entity RE-B is established. These cases will be explained in more detail below with reference to FIGS. 3a, 3b and 3c.

With reference to FIGS. 3a-c examples are provided with respect to a specific network layout and communication protocol. For instance, the examples mention mobile services switching centres, but it will be understood that the embodiments are not limited to mobile networks.

FIG. 3a depicts a call establishment procedure comprising call establishment messages that may be exchanged in the network until the first connection between the calling entity CE-A and the remote entity RE-B reaches the active phase. The following list explains the sequence of events in FIG. 3a.
1. When the calling entity tries to set up a first connection (action a1), an ISUP IAM is received in the service switching entity SSE with indication that connected line information COL is requested for this call (action a2). The request for connected line information COL for this first connection is based on subscription information of that subscriber. Service switching entity SSE invokes an IN service in the service control entity SCE by sending a CAP Initial DP (IDP) message to the service control entity SCE (action a3).
2. The service control entity SCE asks the service switching entity SSE to send a first indication when disconnect occurs (action a4) and sends a CAP CWA message to the service switching entity SSE to instruct the service switching entity SSE to continue the call establishment procedure (action a5). The service switching entity SSE sends an ISUP Address Complete message (ACM) in backwards direction (action a6); this has the effect that the calling entity CE-A receives a Direct Transfer Application Part (DTAP) Call proceeding message from the mobile services switching centre MSC-A associated with the calling entity CE-A (action a7).
3. ISUP IAM arrives at the mobile services switching centre MSC-B associated with the remote entity RE-B and a DTAP Setup message is sent to remote entity RE-B (actions a8 and a9).
4. The remote entity RE-B returns a DTAP Call Proceeding towards the mobile services switching centre MSC-B associated with the remote entity RE-B (action a10), followed by a DTAP Alerting (action a13). The DTAP Call Proceeding results in an ISUP ACM being sent from the mobile services switching centre MSC-B associated with the remote entity RE-B towards the service switching entity SSE and ISUP CPG being sent from the service switching entity SSE to the mobile services switching centre MSC-A associated with the calling entity CE-A (actions all and a12).
   The DTAP Alerting results in an ISUP CPG being sent from the mobile services switching centre MSC-B associated with the remote entity RE-B towards the service switching entity SSE, an ISUP CPG being sent from the service switching entity SSE to the mobile services switching centre MSC-A associated with the calling entity CE-A and a DTAP Alerting being sent from the mobile services switching centre MSC-A associated with the calling entity CE-A to the calling entity CE-A (actions a14, a15 and a18). The calling entity CE-A now starts alerting.
5. Remote entity RE-B sends a DTAP Connect message (action a16) to the mobile services switching centre MSC-B associated with the remote entity RE-B, which generates an ISUP ANM (action a17), containing the connected line information COL of the remote and now connected entity RE-B.
6. The ISUP ANM is received in the mobile services switching centre MSC-A associated with the calling entity CE-A (action a19) which maps it into a DTAP Connect message (action a20) containing, amongst others, the connected line information COL.

Part of the call establishment procedure is the receiving of the ISUP answer message (ANM). This answer message comprises the connected line information COL and is forwarded in backward direction to the calling entity CE-A.

Follow-On Call

FIG. 3b shows what happens when the service control entity SCE orders the establishment of a follow-on call, i.e. establishment of a second connection.
1. Remote entity RE-B disconnects from the first connection of the call by sending a DTAP Disconnect message (action b1) to the mobile services switching centre MSC-B associated with the remote entity RE-B, which maps this message to ISUP Release (REL) (action b2).
2. ISUP REL message is received in service switching entity SSE which reports the reception of ISUP REL to the service control entity SCE by sending a first indication that the first connection between the calling entity CE-A and remote entity RE-B has been disconnected (action b3), for example in a CAP Event Report BCSM (ERB) operation. The ERB operation informs the service control entity SCE that the first connection with the connected remote entity RE-B is released.
3. The service control entity SCE decides to establish a follow-on call, i.e. a second connection with a second remote entity RE-C, by sending an instruction to the service switching entity SSE, for example in a CAP Connect operation (action b4).
4. As a result a new ISUP IAM is sent to the mobile services switching centre MSC-C associated with a second remote entity RE-C (action b5); this ISUP IAM will, similar to the ISUP IAM associated with the first connection from the calling entity CE-A, contain the request for connected line information COL.
5. From this point onwards, the message sequence is very similar to that in FIG. 3a:
   a. DTAP Setup is delivered to the mobile services switching centre MSC-C associated with the second remote entity RE-C (action b6).
   b. The mobile services switching centre MSC-C associated with the second remote entity RE-C replies with a DTAP Call proceeding message (action b7) and DTAP Alerting message (action b9). The mobile services switching centre MSC-C associated with the second remote entity RE-C maps DTAP Call proceeding and DTAP Alerting in an ISUP ACM and an ISUP CPG respectively (actions b8 and b10). Then service switching entity SSE receives these ACM and CPG, mapping the ACM in another CPG toward the mobile services switching centre MSC-A associated with the calling entity CE-A; this because an ACM has already been sent to CE-A (actions b11 and b12).
   c. The second remote entity RE-C sends a DTAP Connect message to the mobile services switching centre MSC-C associated with the second remote entity RE-C (action b15). This DTAP message is mapped in an ISUP ANM in backwards direction (action b16). This message will contain the connected line information COL of the second remote entity RE-C of this follow-on call.
   d. This ISUP ANM can't be sent further by the service switching entity SSE, because ISUP does not allow sending twice an ISUP ANM. So the mobile services switching centre MSC-A associated with the calling entity CE-A will not receive the connected line information COL of the second remote and now connected entity RE-C of the follow-on call.

From FIGS. 3a and 3b it can be deduced that a problem may arise when a first connection between a calling entity CE-A and a first remote entity RE-B is disconnected to establish a second connection with a second remote entity RE-C and, in this example, an answer message (such as an ISUP ANM) is received twice in the service switching entity SSE of the calling entity CE-A. In such case, the connected line information of the second remote entity RE-C can't be sent towards the calling entity CE-A.

Based on the above explanation it will be understood that in a call establishment procedure (comprising a plurality of call establishment messages as shown in FIGS. 3a and 3b) for a connection initiated by a calling entity CE-A, cases may occur in which the eventual connected second remote entity RE-C is not the same as the called first remote entity RE-B, but that the connected line information COL can nevertheless not be presented to the calling entity CE-A. In such cases, the service switching entity SSE first receives a call establishment message comprising connected line information COL of the first remote entity RE-B in response to which the Connected Line Identification Presentation (COLP) Supplementary Service of the calling entity CE-A provides the identity of the connected first remote entity RE-B to the calling entity CE-A, i.e. connected line information COL is forwarded to the calling entity CE-A.

The service switching entity SSE subsequently receives further call establishment messages, comprising connected line information COL of a second remote entity RE-C (e.g. after call has been rerouted due to CAP Connect operation). However, the service switching entity SSE is not capable to forward this connected line information COL of this second remote entity RE-C to the calling entity CE-A.

User Interaction

In some cases interaction is required between the calling entity CE-A and a first remote entity RE-B, such as for instance a user interaction device, before a connection towards a second remote entity RE-C is established. A user interaction device may be a specialized resource function (SRF) that can be implemented as a stand alone device, e.g. as an intelligent peripheral, or that can be co-located with a service switching entity SSE. For example, the calling entity CE-A may be requested to key in the code of a preferred carrier; or the calling entity CE-A may receive a message indicating the cost of the call and is requested to confirm that (s)he actually wants to establish the call. In order to facilitate such user interaction with the calling entity, an ‘early answer’ message is generated by the service control entity SCE and is sent to the calling entity. FIG. 3c schematically shows a case of an early (ISUP) answer message sent to the calling entity for the purpose of facilitating user interaction with the calling entity CE-A.

Actions c1, c2 and c3 are similar to actions a1, a2 and a3 described above. In this case the service control entity SCE sends a Connect to Resource (CTR) operation (action c4) and a Prompt and Collect User Information (P&C) operation (action c5) to the service switching entity SSE, to invite the calling entity CE-A to enter one or more digits on a keypad of the calling entity CE-A, for instance being a mobile phone. These digits will be transmitted through the speech path and will be detected by the service switching entity SSE, if the SRF is co-located with the SRF, or by an external user interaction device. The service switching entity SSE or the external user interaction device will report the detected digits to the service control entity SCE.

Actions c6 and c7 are similar to actions a6 and a7 described above.

For receiving these digits in the service switching entity SSE or in the external user interaction device, the speech path between the calling entity CE-A and the service switching entity SSE or the external user interaction device needs to be established in both directions, thus establishing a first connection between the calling entity CE-A and the first remote entity. Hereto, the service control entity SCE may include a ‘both way through connected’ indication in the CTR operation sent to the service switching entity

SSE (action c4). The effect of the presence of this indication in CTR is that the service switching entity SSE sends an early answer to the calling entity CE-A (actions c8 and c9). However, the sending of the early answer to the calling entity CE-A has the effect that the first connection between the calling entity CE-A and the service switching entity SSE transits to the ‘active state’. When this first connection is in active state, the service switching entity SSE can no longer send connected line information to the calling entity CE-A during this call, because no further ISUP ANM or ISUP CON can be sent towards the mobile services switching centre MSC-A associated with the calling entity CE-A.

The response from the calling entity CE-A, in the form of digits pressed on the keypad, is detected in the service switching entity SSE and is reported to the service control entity SCE in a Specialised resource report (SRR) operation (action c10). The service control entity SCE will, in response, disconnect the calling entity CE-A from the first remote entity, i.e. disconnect the calling entity CE-A from the specialized resource function. Hereto, the service control entity SCE sends a Disconnect forward connection (DFC) operation (action c11) to the service switching entity SSE. In order to establish the connection between the calling entity CE-A and the second remote entity, the service control entity SCE sends a Continue (CUE) operation or a Continue with argument (CWA) operation (action c12).

Actions c13, c14, c15, c16, c17, c18, c19 and c20 are similar to actions a8, a9, a10, a11, a13, a14, a16, all described above.

Based on the above explanation it will be understood that in a call establishment procedure (comprising a plurality of call establishment messages) for a connection initiated by a calling entity, in cases that user interaction is required, the connected line information COL of the second remote entity can't be forwarded to the calling entity CE-A.

In the two cases described above with reference to FIGS. 3a, 3b and 3c, the connected line information COL of the remote entity (not necessarily being the called entity) can't be presented to the calling entity CE-A. This may be the case when the service switching entity SSE has already sent an answer message to the calling entity CE-A, such as an ISUP ANM or an ISUP CON, and the call is rerouted by the service switching entity SSE, under control of the service control entity SCE. This is also the case when an early answer is generated to enable user interaction.

It will be understood that the above behaviour is a limitation of the COLP service. Even when the connected remote entity is provisioned with the COLR service, and the calling party is provided with the capability to override the COLR there may be call cases where connected line information COL of the connected remote entity, whether or not marked as ‘presentation restricted’, can't be provided to the calling entity CE-A.

### SUMMARY

It is an object to improve the transmitting of connected line information in a telecommunications network.

According to an aspect there is provided a method for transmitting connected line information to a calling entity in a telecommunications network. A first connection in the telecommunications network between the calling entity and a first remote entity has been disconnected. The telecommunications network comprises a service control entity and a service switching entity. The service switching entity receives a first instruction from the service control entity to establish a second connection between the calling entity and a second remote entity, receives a second instruction from the service control entity comprising a connected line notification indicator, receives an indication that the second connection between the calling entity and the second remote entity has been established comprising connected line information of the second remote entity, and sends towards the calling entity a message comprising the connected line information of the second remote entity, based on the connected line notification indicator.

The first remote entity may be a user interaction device, such as a specialized resource function (SRF) or a remote mobile or fixed device. The message comprising the connected line information may be an ISUP Facility message.

According to an embodiment the service switching entity receives an indication that the first connection between the calling entity and the first remote entity has been disconnected and sends the indication to the service control entity.

According to a further aspect there is provided a service switching entity adapted to perform such a method.

According to a further aspect there is provided a method for transmitting connected line information to a calling entity in a telecommunications network. A first connection in the telecommunications network between the calling entity and a first remote entity has been disconnected. The telecommunications network comprises a service control entity and a service switching entity. The service control entity sends a first instruction to the service switching entity to establish a second connection to a second remote entity, determines a connected line notification indicator indicating whether the connected line information of the second remote entity is to be sent towards the calling party, sends a second instruction to the service switching entity comprising the connected line notification indicator.

The first remote entity may be a user interaction device, such as a specialized resource function (SRF) or a remote mobile or fixed device. The message comprising the connected line information may be an ISUP Facility message.

According to an embodiment the service control entity receives an indication from the service switching entity that the first connection between the calling entity and the first remote entity has been disconnected.

According to a further aspect there is provided a service control entity adapted to perform such a method.

According to an aspect there is provided a computer program loadable into a processing unit of a service control entity, the computer program comprising portions of software code adapted to perform the method described above.

According to an aspect there is provided a computer program loadable into a processing unit of a service switching entity, the computer program comprising portions of software code adapted to perform the method described above.

According to an aspect there is provided a computer-readable medium product comprising such a computer program.

The above aspects provide a way of providing connected line information to a calling entity in situations of a follow-on call or user interaction.

### BRIEF DESCRIPTION OF THE DRAWINGS

Embodiments will now be described, by way of example only, with reference to the accompanying schematic drawings in which corresponding reference symbols indicate corresponding parts, and in which:

FIG. 1 schematically shows a telecommunications network arranged to set up a connection between a calling entity and a remote entity according to the prior art,

FIG. 2 schematically shows a telecommunications network,

FIGS. 3a, 3b and 3c schematically show a flow diagram according to the prior art,

FIG. 4 schematically shows a general computer,

FIG. 5 schematically shows a block diagram of an embodiment of a service control entity,

FIG. 6 schematically shows a block diagram of an embodiment of a service switching entity,

FIG. 7 schematically shows flow diagram according to an embodiment,

FIG. 8 schematically shows flow diagram according to an embodiment,

FIG. 9 schematically shows signal sequence diagram for a follow-on call according to an embodiment, and

FIG. 10 schematically shows signal sequence diagram for a call preceded by user-interaction according to an embodiment.

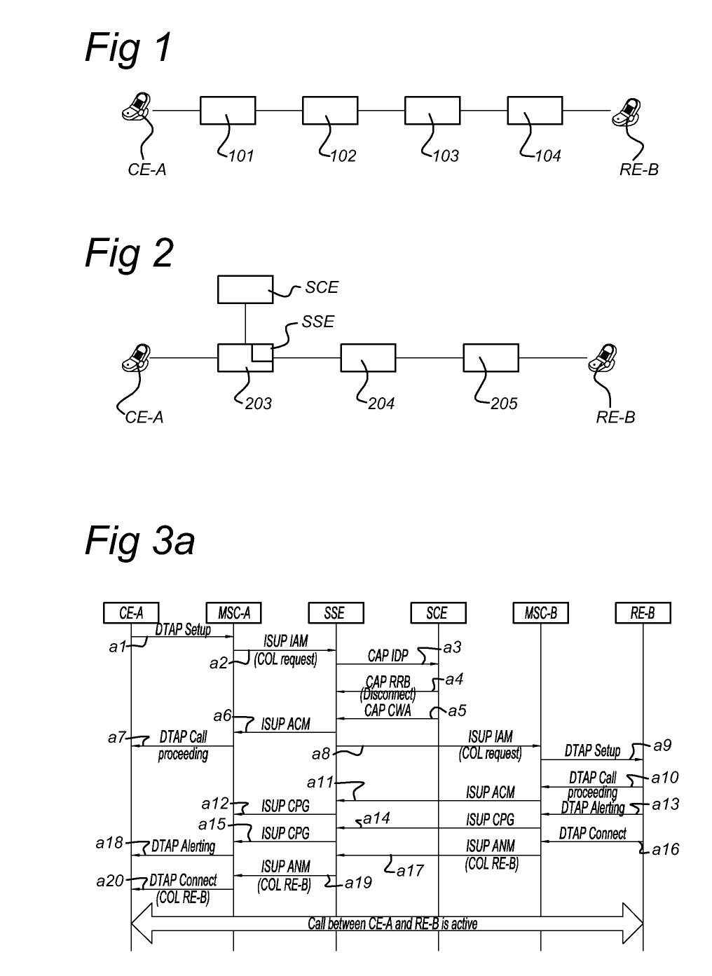

### DETAILED DESCRIPTION

With reference to FIG. 2 an explanation is provided above of a network, comprising network elements such as a service switching entity SSE for switching tasks and a service control entity SCE comprising the service intelligence or logic. Both the service control entity SCE and the service switching entity SSE may be formed as computers, embodiments of which are described below. Of course, also other network elements, such as switching nodes, calling entities, remote entities may be formed as computers.

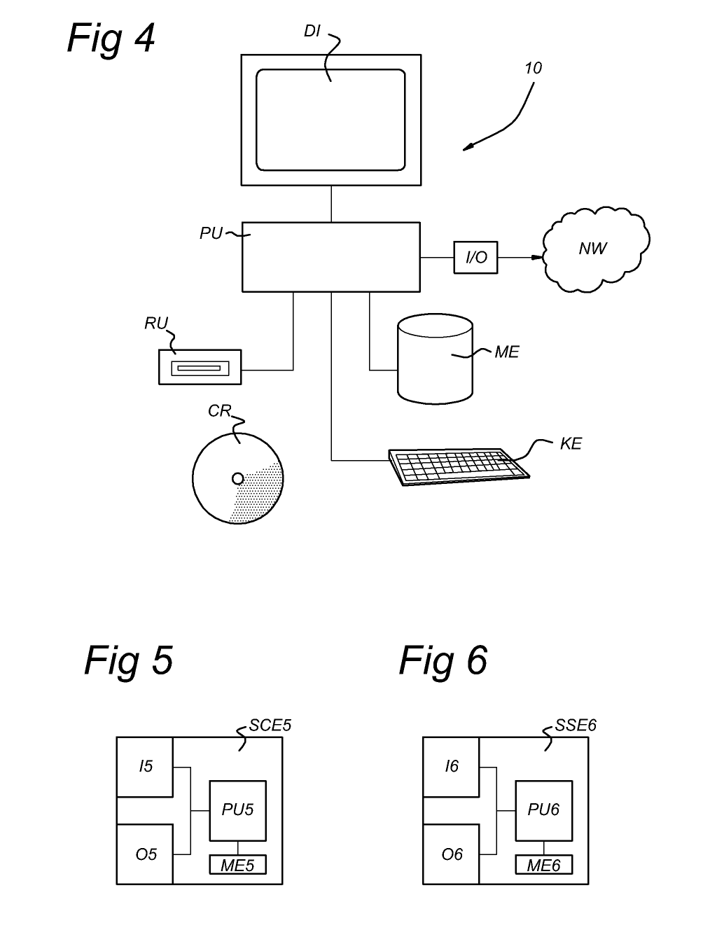

FIG. 4 schematically shows a general embodiment of an example of a computer. The description may refer to several kinds of devices, such as personal computers, servers, laptops, personal digital assistances (PDA), palmtops, telephones. All these devices may be different kind of computers.

FIG. 4 shows a schematic block diagram of an embodiment of a computer 10, comprising a processor unit PU for performing arithmetical operations. The processor unit PU is connected to memory ME that may store instructions and data. The memory ME may be formed by one or more of a tape unit, hard disk, Read Only Memory (ROM), Electrically Erasable Programmable Read Only Memory (EEPROM), and Random Access Memory (RAM). The memory may be loaded with instructions that are readable and executable by the processor unit PU to enable the computer 10 to perform in accordance with the embodiments described.

The processor unit PU may also be connected to one or more input devices, such as a keyboard KE, and one or more output devices, such as a display DI, and one or more reading units RU to read for instance a floppy, CD ROM's CR or a DVD.

The computer 10 shown in FIG. 4 also comprises an input output device (I/O) that is arranged to communicate with other computers (not shown) via a network, for instance the intelligent network. Of course, the input output device (I/O) may also be formed as a separate input device I and output device O.

However, it should be understood that there may be provided more and/or other memory units, input devices and read devices known to persons skilled in the art. Moreover, one or more of them may be physically located remote from the processor unit PU, if required. The processor unit PU is shown as one box, however, it may comprise several processor units functioning in parallel or controlled by one main processor unit that may be located remote from one another, as is known to persons skilled in the art.

It is observed that, although all connections in FIG. 4 are shown as physical connections, one or more of these connections can be made wireless. They are only intended to show that “connected” units are arranged to communicate with one another in someway.

The computer 10 is shown as a computer, but can be any signal processing system with analogue and/or digital and/or software technology arranged to perform the functions discussed here.

As described above, a CAMEL based Intelligent Network comprises as main entities a service switching entity SSE for switching tasks, also referred to as SSF (Service Switching Function) or gsmSSF (GSM Service Switching Function) and a service control entity SCE comprising the service intelligence or logic also referred to as SCF (Service Control Function) or gsmSCF (GSM Service Control Function). Both the service control entity SCE and the service switching entity SSE may also be formed as computers, embodiments of which are described below.

Service Control Entity

FIG. 5 depicts an embodiment of a service control entity SCE comprising an input device IS for receiving messages and an output device O5 for transmitting messages, a processor unit PU5 for processing messages and information and memory ME5 for storing and/or obtaining of information.

A service control entity SCE may be a stand alone device and input device I5 and output device O5 being external interfaces like a receiving unit for receiving messages and a transmission unit for transmitting messages, respectively. However, it is also conceivable that a service control entity SCE is operating at a switching node, e.g. as a hardware and/or software sub-unit of the switching node. The service control entity SCE may be installed and operated at the switching node sharing none of the units I5, O5, P5, ME5 with the switching node or sharing at least one of the units I5, O5, P5, ME5 with units of a switching node. An alternative embodiment is a service control entity SCE according to a computer program loaded into the processing unit of a switching node.

Service Switching Entity

FIG. 6 depicts an embodiment of a service switching entity SSE comprising an input device I6 for receiving messages and an output device O6 for transmitting messages, a processor unit PU6 for processing messages and information, and memory ME5 for storing and/or obtaining of information.

A service switching entity SSE may be a stand-alone device and input device I6 and output device O6 being external interfaces like a receiving unit for receiving messages and a transmission unit for transmitting messages, respectively. Preferably, a service switching entity SSE is operating at a switching node, such as a MSC, e.g. as a hardware and/or software sub-unit of the switching node. The service switching entity SSE may be installed and operated at the switching node sharing none of the units I6, O6, PU6, ME6 with the switching node or sharing at least one of the units I6, O6, PU6, ME6 with units of a switching node comprising an input device for receiving messages, an output unit for sending messages, a processor unit for processing messages and information, and preferably a memory. According to an embodiment a service switching entity SSE is provided according to a computer program loaded into the processor unit of a switching node, thus sharing at least the processor unit with the input device I6.

CAMEL

As described above with reference to FIG. 2, the service control entity SCE communicates with the service switching entity SSE using an intelligent network protocol. An example of such an intelligent network protocol is CAMEL.

The Customized Applications for Mobile network Enhanced Logic (CAMEL) feature is a GSM Phase 2+ and 3G network feature providing the mechanisms to support operator-specific services that are not covered by standardized GSM or 3G services, even when a mobile subscriber is roaming outside his/her Home PLMN (HPLMN).

### Embodiments

The service control entity SCE can be aware of call cases in which the calling entity CE-A will not be able to receive the connected line information COL of the connected second remote entity RE-C. Reason may be that the service control entity SCE may itself have applied the user interaction or may itself have established the follow-on call. And hence, the service control entity SCE knows that the calling entity CE-A has received an (early) Answer message and that the calling entity CE-A can therefore not receive COL information (any more).

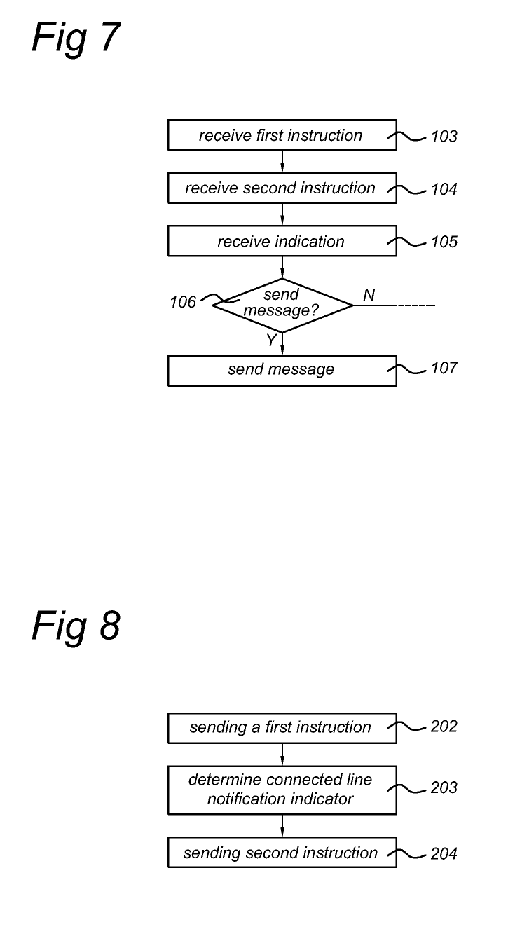

According to an embodiment, a method is provided that may be executed by a service switching entity SSE in a telecommunications network comprising a service control entity SCE and the service switching entity SSE. The method is shown in FIG. 7 and is described below.

Optionally and not shown in FIG. 7, an indication that a first connection between a calling entity and a first remote entity has been disconnected is received. The first remote entity may be a remote mobile telephone corresponding to the follow-on call example provided above or may be a user interaction device, such as a SRF, corresponding to the user interaction example provided above. As a response, the indication may be sent to the service control entity SCE. These optional actions relate to the embodiment of the follow on call as explained.

In an action 103 a first instruction is received from the service control entity SCE to establish a second connection between the calling entity CE-A and a second remote entity RE-C.

In a further action 104 a second instruction is received from the service control entity SCE comprising a connected line notification indicator. The connected line notification indicator is an indicator that indicates to the service switching entity whether the connected line information COL shall be explicitly forwarded to the calling entity CE-A or not.

In a next action 105 an indication is received that the second connection between the calling entity CE-A and the second remote entity RE-C has been established comprising connected line information COL of the second remote entity RE-C.

Next in action 106 it is decided whether or not to send the connected line information of the second remote entity to the calling entity CE-A based on the connected line notification indicator received in action 104. If the connected line notification indicator is to be forwarded to the calling entity CE-A, this is finally done in action 107, wherein a message comprising the connected line information of the second remote entity is sent to the calling entity CE-A.

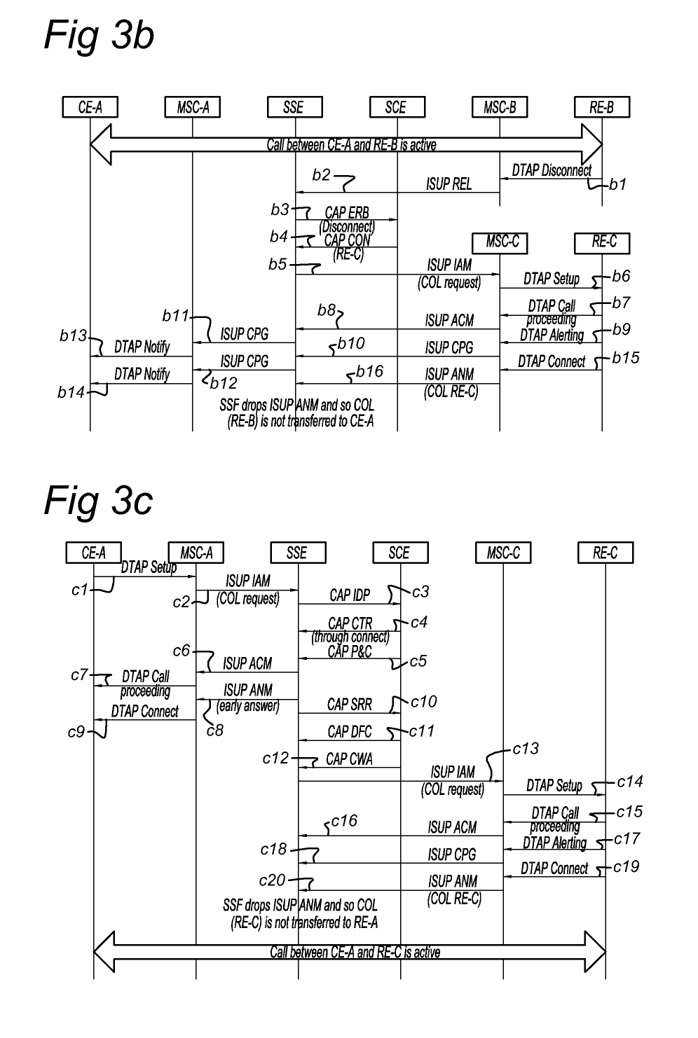

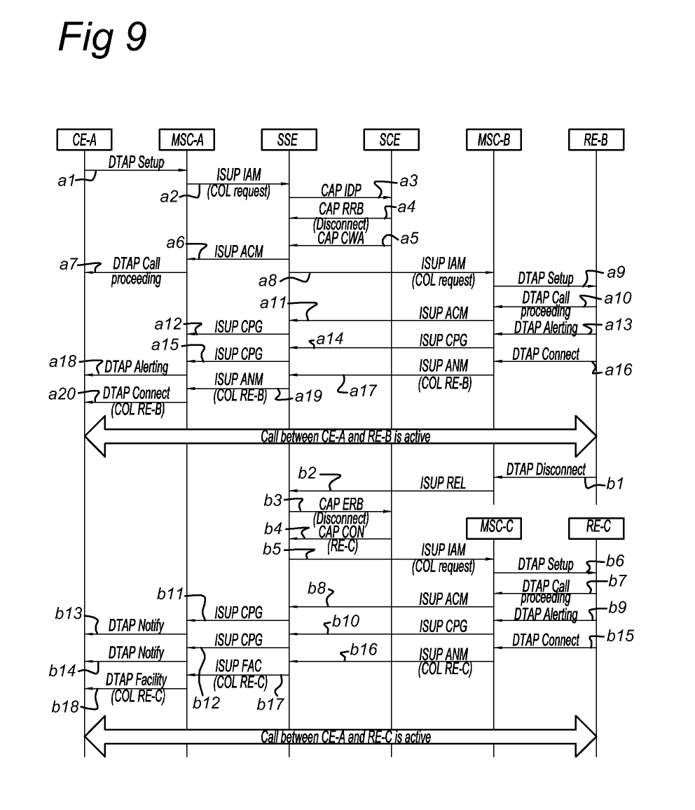

In line with the examples provided in FIGS. 3a-c and in FIGS. 8 and 9 below, the message comprising the connected line information of the second remote entity that is sent to the calling entity CE-A may be a Facility message. It will be understood that the service switching entity SSE and the service control entity SCE may be arranged to communicate with each other using the CAMEL protocol.

An embodiment of a service switching entity SSE as shown in FIG. 6 is provided that is arranged to perform the method as described with reference to FIG. 7.

A service switching entity SSE may be provided as shown in FIG. 6, for performing a method for transmitting connected line information to a calling entity in a telecommunications network, wherein a first connection between a calling entity and a first remote entity has been disconnected, the telecommunications network comprising a service control entity and a service switching entity. The service switching entity SSE comprises an input device I6 for receiving messages and an output device O6 for transmitting messages, a processor unit PU6 for processing messages and information, and memory ME5 for storing and/or obtaining of information.

The input device I6 may be adapted to receive a first instruction from the service control entity to establish a second connection between the calling entity and a second remote entity. The processing unit PU6 may be adapted to process the first instruction.

Furthermore, the input device I6 may be adapted to receive a second instruction from the service control entity comprising a connected line notification indicator.

Additionally, the input device I6 may be adapted to receive an indication that the second connection between the calling entity and the second remote entity has been established comprising connected line information of the second remote entity.

Accordingly, the processing unit PU6 may be adapted to process the second instruction from the service control entity comprising the connected line notification indicator and to process the indication that the second connection has been established. The processing unit PU6 may be further adapted to send via output device O6 towards the calling entity a message comprising the connected line information of the second remote based on the connected line notification indicator.

According to an embodiment there is provided a computer program loadable into a processing unit of a service switching entity SSE, the computer program comprising portions of software code adapted to perform the method as described with reference to FIG. 7. The computer program may be comprised by a computer-readable medium.

According to an embodiment, a method is provided that may be executed by a service control entity SCE in a telecommunications network comprising the service control entity SCE and a service switching entity SSE. The method is shown in FIG. 8 and comprises the following actions:

Optionally, an indication from the service switching entity SSE is received that a first connection between a calling entity and a first remote entity has been disconnected. The first remote entity may be a remote mobile telephone corresponding to the follow-on call example provided above.

In action 202 a first instruction is sent to the service switching entity SSE to establish a second connection to a second remote entity.

In a next action 203 a connected line notification indicator is determined indicating whether the connected line information of the second remote entity is to be forwarded towards the calling party. The connected line notification indicator is an indicator that indicates to the service switching entity SSE whether the connected line information COL is to be forwarded to the calling entity CE-A or not.

The service control entity SCE may decide about the value of the connected line notification indicator by obtaining information from a database, for instance stored in the memory ME5 of the service control entity. The database may comprise connected line notification indicators associated with dialled numbers, subscriber numbers, subscriber profiles etc. So, based on this type of information, the service control entity SCE may consult the database and determine the value of the connected line notification indicator to be used for this call.

Finally, in a further action 204 an instruction is sent to the service switching entity SSE comprising the connected line notification indicator. It will be understood that the connected line notification indicator may have two values, for instance may have a positive value or a negative value, based on which the service switching entity SSE decides whether to send towards the calling entity a message comprising the connected line information of the second remote entity.

It will be understood that the service switching entity SSE and the service control entity SCE may be arranged to communicate with each other using the CAMEL protocol.

An embodiment of a service control entity SCE as shown in FIG. 5 is provided that is arranged to perform the method as described with reference to FIG. 8.

A service control entity SCE may be provided as shown in FIG. 5, for performing a method for transmitting connected line information to a calling entity in a telecommunications network, wherein a first connection between a calling entity and a first remote entity has been disconnected, the telecommunications network comprising a service control entity and a service switching entity. The service control entity SCE comprises an input device I5 for receiving messages and an output device O5 for transmitting messages, a processor unit PU5 for processing messages and information and memory ME5 for storing and/or obtaining of information.

The processing unit PU5 may be adapted to send via the output device O5 a first instruction to the service switching entity to establish a second connection to a second remote entity.

Furthermore, the processing unit PU5 may be adapted to determine a connected line notification indicator indicating whether the connected line information of the second remote entity is to be sent towards the calling party.

The processing unit PU5 may be further adapted to send via output device O5 a second instruction to the service switching entity comprising the connected line notification indicator.

According to an embodiment there is provided a computer program loadable into a processing unit of a service control entity SCE, the computer program comprising portions of software code adapted to perform the method as described with reference to FIG. 8. The computer program may be comprised by a computer-readable medium.

### Examples

FIG. 9 shows a signalling sequence related to the embodiments when applied to the example of a follow-on call. Actions a1-a20 and b1-b16 are already described above with reference to FIG. 3a. When the first remote entity RE-B releases the call (action b1), the service switching entity SSE receives an indication that the first connection between the calling entity and a first remote entity is disconnected (action b2) and reports this to the service control entity SCE (b3). The service control entity SCE instructs the service switching entity SSE to establish a follow-on call, i.e. a second connection, by sending for example a CAP Connect (CON) operation to the service switching entity SSE (action b4). The CON operation includes the destination number for the follow-on call, i.e. the number of the second remote entity RE-C. The service control entity SCE determines a connected line notification indicator for the second connection and sends the connected line notification indicator to the service switching entity SSE, for example in the CON operation of action b4. This connected line notification indicator indicates to the service switching entity SSE, by virtue of having a designated value, that the service switching entity SSE shall forward a COL, when received for this follow-on call, i.e. the second connection, towards the calling entity CE-A. The service switching entity SSE may, after having received the COL, forward the COL towards the calling entity CE-A in an ISUP Facility (FAC) message (action b17). The mobile services switching centre MSC-A associated with the calling entity CE-A may, when receiving this ISUP FAC from the service switching entity SSE, transcribe the ISUP FAC to a DTAP Facility message, containing the connected line information COL (action b18).

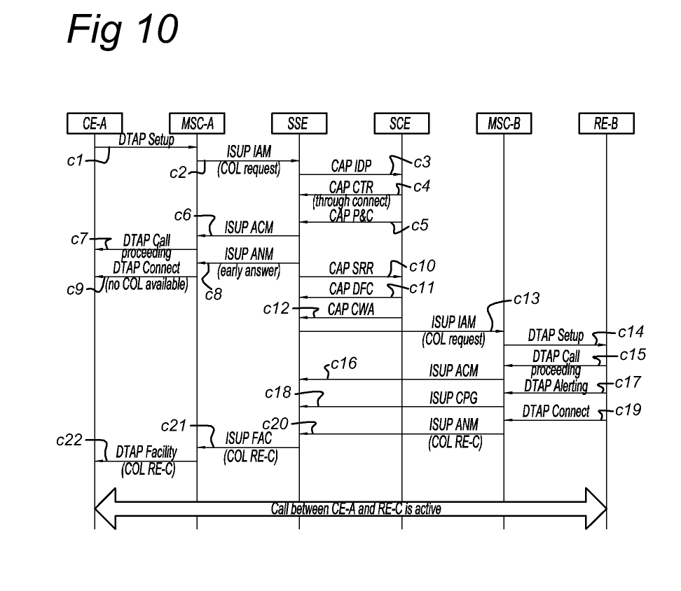

FIG. 10 shows a signalling sequence related to the embodiments when applied to a call that is preceded by user interaction. Actions c1-c20 are already described above with respect to FIG. 3c. The service control entity SCE initiates user interaction with the calling entity CE-A, for which it is required that the service switching entity SSE sends, upon being instructed by the service control entity SCE, an ISUP Answer message (ANM) towards the calling entity CE-A, establishing the first connection. There is at this point in the call establishment process no connected line information COL available yet. Hence, the DTAP Connect message (action c9) that is sent from the mobile services switching centre MSC-A associated with the calling entity CE-A to the calling entity CE-A, resulting from the ISUP ANM (action c8) sent from service switching entity SSE to the mobile services switching centre MSC-A associated with the calling entity CE-A, does not contain connected line information COL.

When the user interaction is completed the service control entity SCE instructs the service switching entity SSE to establish the outgoing call, i.e. the second connection, by sending for example a CAP Continue with argument (CWA) operation to the service switching entity SSE (action c12). The CWA operation contains the connected line notification indicator. This parameter indicates to service switching entity SSE, by virtue of having a designated value, that the service switching entity SSE shall forward a connected line information COL, when received for this call, towards the calling entity CE-A. The service switching entity SSE may, after having received the COL, forward the connected line information COL towards the calling entity CE-A in an ISUP Facility (FAC) message (action c21). The mobile services switching centre MSC-A may, when receiving this ISUP FAC from service switching entity SSE, transcribe the ISUP FAC to a DTAP Facility message, containing the connected line information COL (action c22).

Further Remarks

The invention may be implemented in any telecommunication network like a GSM, Code Division Multiple Access (CDMA), Time Division Multiple Access (TDMA) or Universal Mobile Telecommunication System (UMTS). A service control entity is typically embodied in a single device or may be distributed over several devices. A service control entity and a service switching entity may be implemented as separate functions on the same device or platform.

Also provided is a computer program loadable into a processing unit of a service control entity, where the computer program comprises portions of software code adapted to perform at least one of the embodiments and methods described above.

Also provided is a computer program loadable into a processing unit of a service switching entity, where the computer program comprises portions of software code adapted to perform at least one of the embodiments and methods described above.

Also provided is a computer-readable medium product comprising at least one of the computer programs as described above.

The descriptions above are intended to be illustrative, not limiting. Thus, it will be apparent to one skilled in the art that modifications may be made to the invention as described without departing from the scope of the claims set out below.

1. A method for transmitting connected line information to a calling entity in a telecommunications network, wherein a first connection between a calling entity and a first remote entity has been disconnected, the telecommunications network comprising a service control entity and a service switching entity, wherein the service switching entity performs:
receiving a first instruction from the service control entity to establish a second connection between the calling entity and a second remote entity;
receiving a second instruction from the service control entity comprising a connected line notification indicator;
receiving an indication that the second connection between the calling entity and the second remote entity has been established comprising connected line information of the second remote entity; and
based on the connected line notification indicator sending towards the calling entity a message comprising the connected line information of the second remote entity.

2. The method according to claim 1, wherein the first remote entity is a user interaction device, such as a specialized resource function (SRF).

3. The method according to claim 1, wherein the first remote entity is a remote mobile device or a remote fixed device.

4. The method according to claim 1 wherein the message comprising the connected line information is an ISUP Facility message.

5. The method according to claim 1, further comprising
receiving an indication that the first connection between the calling entity and the first remote entity has been disconnected, sending the indication to the service control entity.

6. (canceled)

7. A method for transmitting connected line information to a calling entity in a telecommunications network, wherein a first connection between a calling entity and a first remote entity has been disconnected, the telecommunications network comprising a service control entity and a service switching entity, wherein the service control entity performs the steps of:
sending a first instruction to the service switching entity to establish a second connection to a second remote entity;
determining a connected line notification indicator indicating whether the connected line information of the second remote entity is to be sent towards the calling party; and
sending a second instruction to the service switching entity comprising the connected line notification indicator.

8. The method according to claim 7, wherein the first remote entity is a user interaction device, such as a specialized resource function (SRF).

9. The method according to claim 7, wherein the first remote entity is a remote mobile device or a remote fixed device.

10. The method according to any claim 7, wherein the method further comprises
receiving an indication from the service switching entity that the first connection between the calling entity and the first remote entity has been disconnected.

11-14. (canceled)
